(19) United States
(12) Patent Application Publication
(10) Pub. No.: US 2014/0297097 A1
(43) Pub. Date: Oct. 2, 2014

(54) SYSTEM AND METHOD FOR GENERATING ALERTS

(71) Applicant: LARRY HURWITZ, Dallas, TX (US)

(72) Inventor: LARRY HURWITZ, Dallas, TX (US)

(21) Appl. No.: 13/853,823

(22) Filed: Mar. 29, 2013

(51) Int. Cl. G07C 5/00

(52) U.S. Cl. CPC G07C 5/008
USPC 701/31.4

(57) ABSTRACT

A system comprising a portable, OBD connectable dongle is in communication with a cellular telephone. The dongle and the cellular telephone are communicatively coupled, allowing the cellular telephone to receive signals from the OBD dongle. The OBD dongle monitors the output signals from the built-in OBD system for a vehicle and relays the signals to the cellular telephone. The cellular telephone is programmatically configured to interpret the signals provided by the OBD system to determine the status of the vehicle and, in certain pre-determined situations, send one or more messages to request assistance or support. The most preferred embodiments of the system are also GSM and GPS enabled, thereby providing GSM and GPS positioning information that can be used in conjunction with the accelerometer data to monitor and detect predetermined events and, based upon the specific nature of the event, generate one or more alerts.

### CROSS REFERENCE TO RELATED APPLICATIONS

This application claims the benefit of U.S. Provisional Patent Application No. 61/617,580 which application was filed on Mar. 29, 2012 and which application is a continuation-in-part of U.S. patent application Ser. No. 12/791,413, which application was filed on Jun. 1, 2010 and is entitled APPARATUS AND METHOD FOR GENERATING ALERTS, which applications are now pending at the United States Patent and Trademark Office and which applications are incorporated herein by reference.

### BACKGROUND OF THE INVENTION

1. Technical Field

This invention relates generally to the field of portable devices capable of emergency communication and more specifically relates to the generation of emergency communication signals using a portable device.

2. Background Art

In recent years, vehicles have been offered with sophisticated onboard communication systems that can be user actuated or event actuated to notify a commercial monitoring center. Generally, a user subscribes to a commercial service and can communicate with that service by pushing a designated button in his or her vehicle. In addition, in the event of an accident, the monitoring center may be automatically notified by the monitoring system in the vehicle so that it can send assistance, such as police or other emergency response personnel.

Because the commercial monitoring system installed in the vehicle often includes global positioning technology (GPS) equipment, it may also be possible to receive position location signals from one or more GPS satellites, allowing the vehicle monitoring system to forward the GPS coordinates of the vehicle to the monitoring center in case of an emergency. The monitoring center can, in turn, relay the GPS coordinates to appropriate parties and notify emergency response personnel as to the location of the vehicle so that the needed assistance will be provided.

While this type of emergency communication system has been a boon for newer vehicles, many older vehicles are not equipped with the sophisticated commercial onboard communication systems and equipment that are becoming commonplace in newer vehicles. For example, while most vehicles and light trucks manufactured after 1996 include a basic onboard diagnostic (“OBD”) system, these industry standard OBD systems are not connected to the outside world and do not include GPS capabilities. Accordingly, the standard OBD equipment cannot communicate with remote communication services or provide the various signals needed to contact commercial monitoring centers and other emergency response organizations and personnel. While many people have cell phones that can be used in an emergency, if a person is injured in an accident or is involved in certain other emergencies, they may not be able to reach or access their cell phone to request assistance and support.

Accordingly, despite the continued development of vehicle onboard technology and cellular phones, there is a continuing need for devices and methods that can assist users in the case of emergency situations that occur away from a commercial onboard communications system.

### BRIEF SUMMARY OF THE INVENTION

A system comprising a portable onboard diagnostic (“OBD”) connectable dongle is in communication with a cellular telephone. The dongle and the cellular telephone are communicatively coupled, allowing the cellular telephone to receive signals from the OBD dongle. The OBD dongle monitors the output signals from the built-in OBD system for a vehicle and relays the signals to the cellular telephone. The cellular telephone is programmatically configured to interpret the signals provided by the OBD system to determine the status of the vehicle and, in certain pre-determined situations, send one or more messages to request assistance or support. The most preferred embodiments of the system are also GSM and GPS enabled, thereby providing GSM and GPS positioning information that can be used in conjunction with the accelerometer data to monitor and detect predetermined events and, based upon the specific nature of the event, generate one or more alerts.

### BRIEF DESCRIPTION OF THE DRAWINGS

The various preferred embodiments of the present invention will hereinafter be described in conjunction with the appended drawings, wherein like designations denote like elements, and:

FIG. 1 is a schematic illustrating a system for generating emergency response signals in accordance with a preferred exemplary embodiment of the present invention; and

FIG. 2 is a flow chart for a method of generating emergency response signals in accordance with a preferred exemplary embodiment of the present invention.

### DETAILED DESCRIPTION OF THE INVENTION

A system comprising a portable OBD connectable dongle is in communication with a cellular telephone. The dongle and the cellular telephone are communicatively coupled, allowing the cellular telephone to receive signals from the OBD dongle. The OBD dongle monitors the output signals from the built-in OBD system for a vehicle and relays the signals to the cellular telephone.

The cellular telephone is programmatically configured to interpret the signals provided by the OBD system to determine the status of the vehicle and, in certain pre-determined situations, send one or more messages to request assistance or support. The most preferred embodiments of the system are also GSM and GPS enabled, thereby providing GSM and GPS positioning information that can be used in conjunction with the accelerometer data to monitor and detect predetermined events and, based upon the specific nature of the event, generate one or more alerts.

On-Board Diagnostics, or “OBD,” is a generic term referring to a vehicle's self-diagnostic and reporting capability. In general, OBD systems give the vehicle owner or a repair technician access to state of health information for various vehicle sub-systems. The amount of diagnostic information available via OBD has varied widely since the introduction of on-board vehicle computers, which made OBD possible. Early instances of OBD would simply illuminate a malfunction indicator light, or “MIL,” if a problem was detected—but would not provide any information as to the nature of the problem. Modern OBD implementations use a standardized digital communications port to provide real-time data in addition to a standardized series of diagnostic trouble codes, or “DTCs,” allowing the owner or technician to rapidly identify and remedy malfunctions within the vehicle.

OBD-II is the most commonly known OBD standard for vehicles currently manufactured in the United States. The OBD-II standard specifies the type of diagnostic connector and its pin out, the electrical signaling protocols available, and the messaging format for communicating with the OBD-II system. It also provides a candidate list of vehicle parameters to monitor along with how to encode the data for each desired parameter. In common use, a repair or diagnostic technician will connect a scanning tool to the OBD-II plug, thereby enabling communication with the OBD-II system. Once connected, the OBD-II diagnostic information can be used to monitor the operational characteristics of the connected vehicle and the OBD-II supplied information can be used to diagnose and repair various vehicle subsystems.

The OBD-II plug connector contains a number of individual pins that are used to convey the vehicle operation information to the OBD-II scanning tool. In most cases, there is also a pin in the OBD-II connector plug that provides power from the vehicle battery for the OBD-II scanning tool, eliminating the need to connect the scanning tool to a separate power source. However, some repaid or diagnostic technicians might may prefer to connect the scanning tool to an auxiliary power source to protect data in the unusual event that a vehicle experiences a loss of electrical power due to a malfunction.

Finally, the OBD-II standard provides an extensible list of DTCs. As a result of this standardization, a single device can query the on-board computer(s) in any vehicle. This OBD-II came in two models OBD-IIA and OBD-IIB. OBD-II standardization was prompted by emissions requirements, and though only emission-related codes and data are required to be transmitted through it, most manufacturers have made the OBD-II Data Link Connector (“DLC”) the only connector in the vehicle through which all systems are diagnosed and programmed. OBD-II DTCs are 4-digit, preceded by a letter: P for engine and transmission (powertrain), B for body, C for chassis, and U for network.

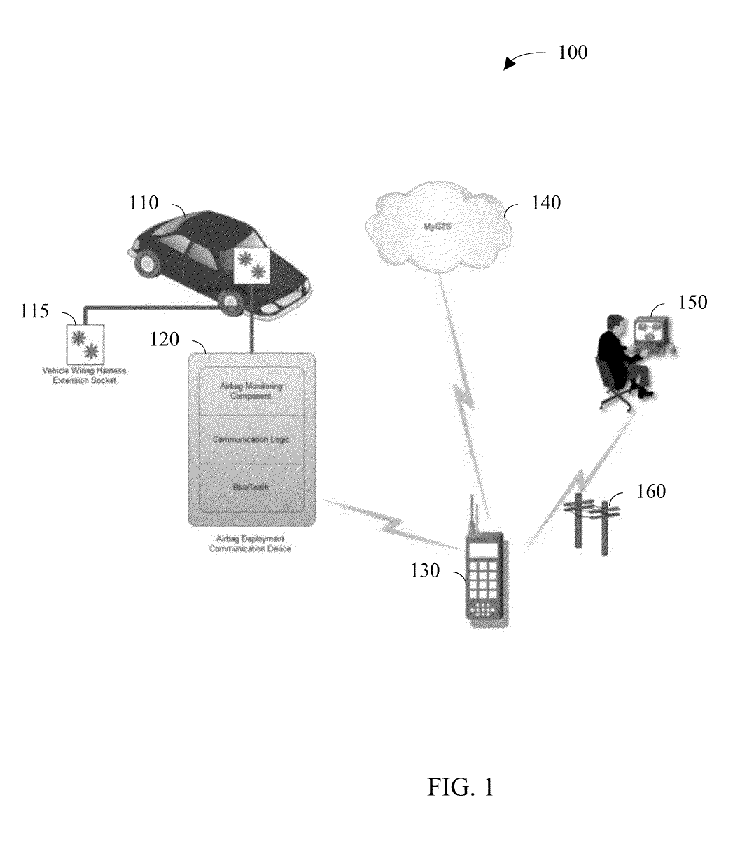

Referring now to FIG. 1, a system 100 for generating emergency signals in accordance with a preferred exemplary embodiment of the present invention is depicted. As shown in FIG. 1, a vehicle 110 is equipped with an OBD wiring harness and extension 115. Wiring harness 115 is, in turn, connected to an OBD connectable dongle 120. With this connection established, the OBD readings from OBD wiring harness and extension 115 can be transmitted from vehicle 110 to handheld device 130 via a wireless communication protocol (e.g. Bluetooth®) or some other wireless communication method known to those skilled in the art.

OBD connectable dongle 120 is a combination software and hardware device that is configured to connect to a standard OBD plug in vehicle 110. Dongle 120 is configured to mate with the standard OBD port found in most vehicles and is able to pass signals received from the OBD port in much the same fashion as an OBD scanning tool. As shown in FIG. 1, dongle 120 comprises an airbag monitoring component, communication logic, and a communication module. The airbag monitoring component is simply a software program that monitors the OBD signals received from vehicle 110 and screens the OBD data flow for the signal or combination of signals that indicates one or more airbags inside of vehicle 110 have been deployed.

Once the airbag deployment signal or signals have been detected, the communication logic associated with dongle 120 will generate one or more messages to handheld device 130, providing an alert signal that one or more of the airbags have been deployed. It is important to note that the airbag deployment alert is an automated response and no user intervention is required for the notification to be issued.

It should be noted that although handheld device 130 is depicted in FIG. 1 as a cellular telephone, other types of devices may be used (e.g., tablet, laptop computer, etc.) and no such device is excluded from consideration. Once the OBD signals have been communicated to handheld device 130, one or more software applications stored in the memory of handheld device 130 can be used to interpret, decode, analyze, and, in certain circumstances, transmit data to a network 140 or a monitoring service located at a monitoring service center 150 (or both) via wireless communication media or wired communication media, including standard phone lines 160, for further action.

Monitoring service center 150 preferably employs personnel who can respond to communications and/or that houses one or more computers which store data concerning customers, translate signal data from handheld device 130 into communications recognized by a human or other computers, and can send communications to other devices, other humans, or one or more users of system 100.

Additionally, the various features and functions of the system may be accessed by multiple users and the administrator of system 100 via a web browser and the Internet. In the most preferred embodiments of the present invention, a Software As A Service (“SAAS”) application is provided for this functionality. By accessing the web-based SAAS application, the user can program various custom features and functions for the user's profile, thereby adapting the functions of system 100 for their specific needs and requirements. This allows for maximum flexibility of system 100 for multiple users.

In at least one preferred embodiment of the present invention, portable handheld device 130 comprises a GSM (Global System for Mobile communication) communications component. GSM is generally most preferred simply because it is a digital mobile telephone system that is widely used in approximately 80 percent of the world or more. GSM uses a variation of Time Division Multiple Access (TDMA) and is the most widely used of the three digital wireless telephone technologies (TDMA, GSM, and CDMA). GSM digitizes and compresses data, then sends it down a channel with two other streams of user data, each in its own time slot. It may operate at one or several frequencies, including the 900 MHz or 1,800 MHz frequency band, or both. Although other digital wireless telephone technologies can also be used, they are not generally as preferred.

Portable handheld device 130 may also comprises a failover component. This function may be implemented by monitoring the strength of the GSM signal, which is supplied by the GSM service provider and changing from the GSM unit if and/or when the signal is not strong enough. The GSM service provider's infrastructure (base units) sends strength indicator information back to handheld device 130, and the protocol of handheld device 130 generally provides a display of this strength indicator information to the user. This function is a common feature employed by handheld units employing GSM, such as ordinary cellular phones.

Portable handheld device 130 also preferably includes the capability of bi-directional text messaging (e.g., short message or “SMS” text messages). Portable handheld device 130 preferably comprises applications or “apps” for completing various tasks such as seeking roadside assistance, information, concierge services, local weather reports, and other assistance as needed. The user can actuate a button that connects the user with monitoring service 150 that can send appropriate assistance to the exact location of the user.

Portable handheld device 130 preferably comprises applications or “apps” for obtaining assistance during times of crisis. For example, during severe weather, natural disasters or other crisis, monitoring service 150 accessible through portable handheld device 130 provides the user with a central point of contact to help the user navigate out of danger, and/or advise the user of events that may be dangerous or undesirable.

Portable handheld device 130 can be provided with convenient features that facilitate communication, for example outbound pre-set one button dialing, inbound cell communication that will allow practically anyone to call the user.

Portable handheld device 130 preferably comprises applications for unit voice monitoring to listen in on voice activity in the surroundings of the unit. In the most preferred embodiments of the present invention, handheld device 130 is a cellular telephone that has been programmed with an application that embodies the various functions and features described below.

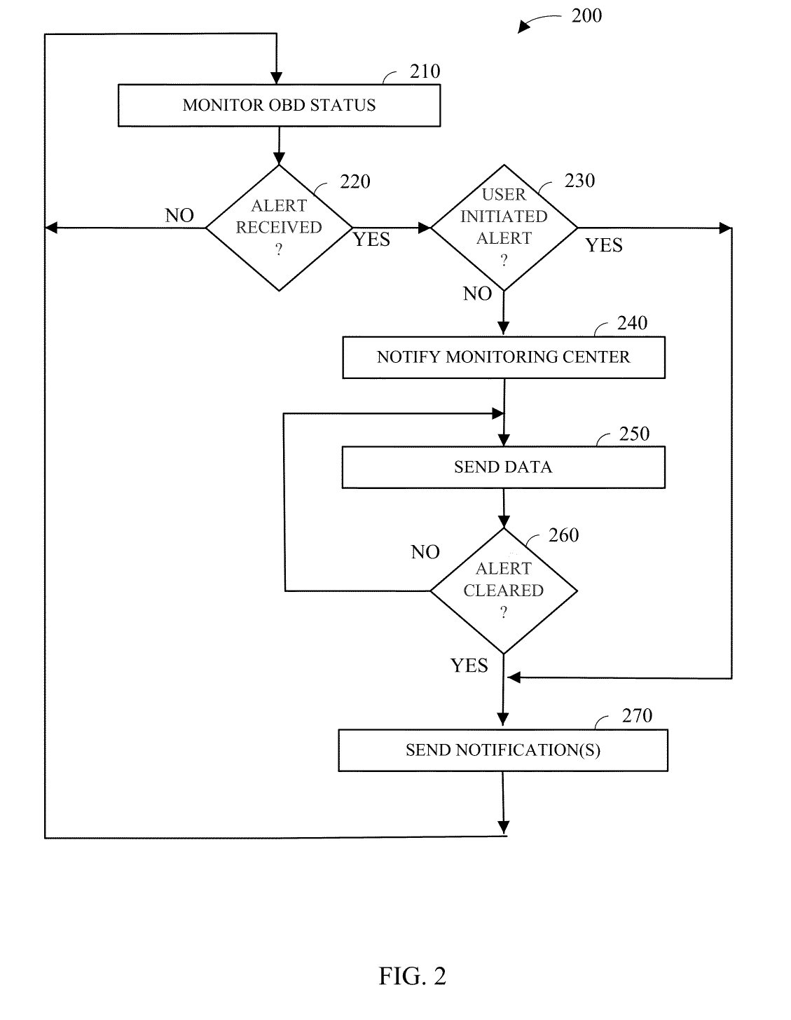

Referring now to FIG. 2, a method for sending emergency signals in accordance with a preferred exemplary embodiment of the present invention is depicted. As shows in FIG. 2, the output of the OBD system of a vehicle (OBD status) will be continually monitored by the dongle. The frequency of the monitoring cycle may be adjusted based on the operating environment. For example, the monitoring cycle may be completed every 5 seconds if the vehicle is stationary or every second if the vehicle is in motion.

If no alert signal (e.g., airbag deployment signal) is detected (step 220=“NO”) then the system will simply continue the monitoring process (step 210). However, once an alert signal has been received from the OBD system (step 220=“YES”), then the system will determine if the alert signal is user generated (step 230=“YES”) or system generated (step 230=“NO”).

The reason for differentiating the origin of the alert signal is to provide for a different response protocol in each of the different situations. For example, the user may issue an alert to indicate that they are out of gas, stuck off the road, or some other situation. However, a system generated alert will indicate that the OBD system has issued the alert and the response will be pre-programmed into the system. In the most preferred embodiments of the present invention, a system generated alert (step 230=“NO”) will indicate that one or more airbags in the vehicle have deployed, most likely as the result of an accident.

If the system alert signal is detected, a signal from the handheld device can be sent to the monitoring service center (step 240). The type of signal to be sent may be a pre-programmed voice message, SMS text message, or similar message that can be used to alert the monitoring service center of the emergency condition that has been detected.

At this point in time, the handheld device will also begin transmitting data from the handheld device to the monitoring service center (step 250). This data may include information such as the airbag-deployed signal, GPS coordinated signals, background audio signals, etc. Once received at the monitoring service center, the monitoring service center personnel can take appropriate steps to ensure that assistance is rendered (e.g., dispatch first responders, etc.). Once the emergency situation has been resolved, the user or first responders can “clear” or disable the alert condition and the status of the alert condition can be tested (step 260).

If the alert condition associated with the automatically generated signal (e.g., airbag deployed signal) has not been cleared (step 260=“NO”), then the handheld device will continue to provide data to the monitoring service center on a regular basis (step 250). The provision of updates from the handheld device will be automatically continued until the alert status has been cleared (step 260=“YES”). At this point in time, the emergency situation has been resolved and any final messages, as determined by the system or the user, may be issued (step 280).

Communications from monitoring service center 150 to the user via handheld device 130 at the incident site can be used to confirm the needs at the incident site if the effect of the incident on the user has left the user in a medical condition permitting him/her to communicate. Monitoring service center can 150 use such communication to reassure the user and/or to gather further details to pass on to emergency responders. Any notified outside parties would respond to the incident scene accordingly. Alternatively, the type of signal and data transmitted via system 100 to monitoring service center 150 can be used by the monitoring service center 150 to accelerate the response, if necessary.

It is anticipated that much of the data necessary for operation of system 100 will be input by the user of portable handheld device 130 or the operators of monitoring service center 150 by accessing the SaaS application via the Internet. Additional data and information may be input by the owner and/or operators of the SaaS website over time. Still more data (e.g. user preferences, contact information, travel patterns, etc.) may be generated automatically and stored by the SaaS application over time as the user and the handheld device 130 interact manually and automatically via the SaaS application. No limitation should be assumed by the lack of inclusion of any specific data element and/or functionality. Those skilled in the art will recognize that additional date elements and/or functions could be included without departing from the spirit and scope of the present invention.

From the foregoing description, it should be appreciated that apparatus and methods for providing introduction for the purpose of enhancing communication capability for vehicles is provided and presents significant benefits that would be apparent to one skilled in the art. Furthermore, while multiple embodiments have been presented in the foregoing description, it should be appreciated that a vast number of variations in the embodiments exist.

Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A system for generating emergency alert signals, the system comprising:
a handheld communication device;
an OBD port connected to a vehicle;
a dongle connected to the OBD port; and
at least one signal transmitted from the OBD port to the handheld communication device via the dongle, the at least one signal communicating the deployment of an airbag inside the vehicle.
